(19) United States
(12) Patent Application Publication
(10) Pub. No.: US 2024/0115024 A1
(43) Pub. Date: Apr. 11, 2024

(54) BAG WITH A DETACHABLE WHEELED CARRY APPARATUS

(71) Applicant: Jessi Park, Maitland, FL (US)

(72) Inventor: Jessi Park, Maitland, FL (US)

(21) Appl. No.: 17/962,666

(22) Filed: Oct. 10, 2022

(51) Int. Cl. A45C 13/38; B62B 5/00

(52) U.S. Cl. CPC A45C 13/385; B62B 5/0083; B62B 2202/26; B62B 2205/30

(57) ABSTRACT

A detachable wheeled bag carrying apparatus that can be attached and detached from a bag, wherein the detachable wheeled bag carrying apparatus allows the bag to be wheeled. The bag has a rectangular shaped material that acts as a strap to bind the bag to the detachable wheeled bag carrying apparatus. The rectangular shaped material can form a pocket to store the detachable wheeled bag carrying apparatus.

### BACKGROUND OF THE INVENTION

A purse is an essential item of a woman's wardrobe. The quality and value of the purse is a measure of the woman's status. Professional women want the ability to have a luxury purse and at the same time have a functional means of carrying documents and items needed for their job. Where a man would carry a brief case, a woman wants to carry a status symbol purse. As the amount of material carried by the woman, the purse gets bigger and bigger, which increases the weight and difficulty in carrying upon the arm.

Wheeled bags are a solution to carrying larger amounts of material, but these bags are not stylist or fashionable. There is a need for a fashionable bag with the ability to have wheels when needed for long transport but removable when not needed. The fashionable bag could be carried upon the arm but used with wheels to ease the effort for long transportation.

Bags are for carrying goods. Bags of different sizes and shapes are known for different carrying purposes. Wheeled bags are also popular for carrying heavy loads, which takes the weight off the hand or shoulder. Although having wheels on bags has become popular for removing the weight from the shoulders, situations may arise where wheels are not desired.

Businesspersons are often confronted with the need to take short-term, overnight business trips. On such trips it is common practice for many businesspersons to take their computer, various business records and personal items. There is a desire for a detachable wheeled bag carrying apparatus for bags that can be attached and detached from the bag.

There are several different types of wheeled bags; however, none solve the problem addressed by the presently disclosed invention; that is, a system and method for carrying a fashionable or luxury bag by a wheeled apparatus and then detaching the wheels to carry the fashionable or luxury bag by the handles over the shoulder or by hand.

U.S. Pat. No. 4,195,676 discloses a wheeled briefcase with wheels permanently attached to the edges of an accordion type briefcase. There is no handle or other method of pulling the briefcase. The briefcase and wheels are not fashionable or appropriate for a businesswoman.

U.S. Pat. No. 4,761,012 discloses a removal case that attaches to a briefcase by straps. The case is large, bulky and a hindrance once removed from the suitcase that is being transported. There is no place or method to store the case after it is removed.

U.S. Pat. No. 5,295,565 discloses a wheeled suitcase with the structure and internal support for the suitcase incorporated into the bag. It is a permanent feature of the suitcase and cannot be removed. It is inappropriate for the transport of a fashionable or luxury bag.

U.S. Pat. No. 6,279,926 discloses a removable wheel system for the transport of golf clubs. The wheels attach to the circular end of the golf club bag. The disclosed removable wheels would not fit a fashionable or luxury bag, nor be appropriate for a rectangular bag.

U.S. Pat. No. 11,129,456 discloses a method of attaching 2 suitcases together so they can be transported by a single wheeled apparatus. The patent covers the attachment method and structures on the suitcases in order to unite the suitcases into a single item.

US Reissue 28,757 discloses a trolley case with permanent wheels that fold together with the briefcase. The wheels can be hidden into the structure of the briefcase. The disclosed case needs to be strong sided in order to support the attached wheels and handle.

The presently disclosed invention is an improvement over previously disclosed wheeled transport methods and systems.

### FIELD OF THE INVENTION

The present invention is related to a detachable wheeled bag carrying apparatus for a fashionable or luxury bag or purse, and more particularly, the present invention relates to the detachable wheeled bag carrying apparatus wheel set for a bag that can be detached and stored on the bag.

### BRIEF SUMMARY OF THE INVENTION

### Brief Description of the Several Views of the Drawing

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 shows the bag with the rectangular shaped material and detachable wheeled bag carrying apparatus (unfolded).

FIG. 2 shows the detachable wheeled bag carrying apparatus (unfolded).

FIG. 3 shows the detachable wheeled bag carrying apparatus (folded).

FIG. 4 shows close-up of telescoping rod.

FIG. 5 shows close-up of wheels.

FIG. 6 shows telescoping rods.

FIG. 7 shows close-up of telescoping rods.

FIG. 8 shows the detachable wheeled bag carrying apparatus.

FIG. 9 shows close-up of wheels and base.

FIG. 10 shows close-up of wheels and reverse side of base

FIG. 11 shows removing folded detachable wheeled bag carrying apparatus from bag with the rectangular shaped material.

FIG. 12 shows unfolding detachable wheeled bag carrying apparatus.

FIG. 13 shows locking telescoping rods to base.

FIG. 14 shows locked telescoping rods to base.

FIG. 15 shows placing bag with the rectangular shaped material onto locked telescoping rods.

FIG. 16 shows placing bag with the rectangular shaped material onto locked telescoping rods.

FIG. 17 shows the bag with the rectangular shaped material connected to the detachable wheeled bag carrying apparatus.

### DETAILED DESCRIPTION OF THE INVENTION

The disclosed invention will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprise”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out embodiments of the invention. The description is not to be taken in a limiting sense but is made merely for the purpose of illustrating the general principles of the invention, since the scope of the invention will be best defined by the allowed claims of any resulting patent.

The present invention relates to a system and method for detachably securing a bag or a purse or similar luggage to a wheeled bag carrying apparatus for ease of transport and ease of attachment and removal from a wheeled bag carrying apparatus. Specifically, the instant system and method relates to releasable or detachably securing or affixing a bag to a wheeled bag carrying apparatus.

For those who want to be fashionable and still carry a heavy bag or suitcase can be problematic at best; and at worst, impossible; especially for those with limited strength or stature. Women, for example, suffer from having to carry a large purse or bag during travel which is heavy and often of a large size.

There are no known systems nor methods wherein a luxury purse or luggage is detachably affixed to a wheeled bag carrying apparatus.

It is an object of the invention to overcome the shortcomings of the prior art.

Disclosed is a detachable wheeled bag carrying apparatus for bags that can be attached or detached, when required. See Table 1 for details of the disclosed invention.

TABLE 1

| | |
|---|---|
| 1 | bag |
| 2 | rectangular shaped material |
| 3 | left side |
| 4 | right side |
| 5 | bottom |
| 6 | zipper |
| 7 | top |
| 8 | detachable wheeled bag carrying apparatus |
| 9 | opening |
| 10 | base |
| 11 | reverse side |
| 12 | wheels |
| 13 | connection between wheels and base |
| 14 | hinges |
| 15 | telescoping rods |
| 16 | tabs |
| 17 | left telescoping rod |
| 18 | right telescoping rod |
| 19 | cross support |
| 20 | handle |
| 21 | button |
| 22 | circular shaped material |

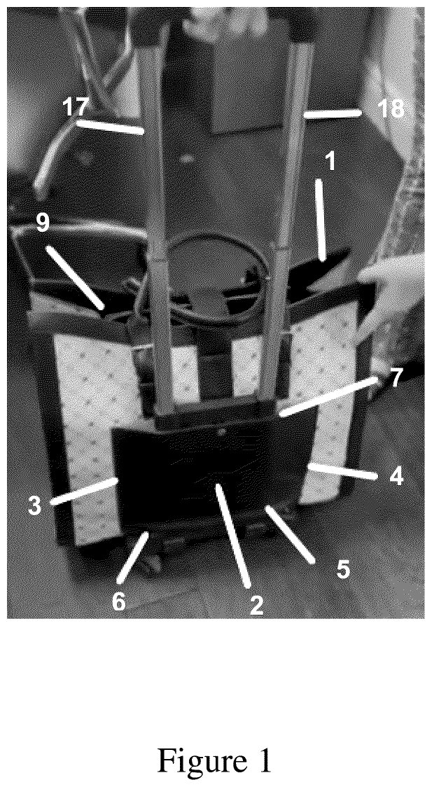

FIG. 1 shows an embodiment of the bag with the rectangular shaped material. The bag 1 has a rectangular shaped material 2 on one side of the bag 1. The rectangular shaped material 2 is permanently attached to the bag 1 along the left side 3 and right side 4 of the rectangular shaped material 2. The bottom 5 of the rectangular shaped material 2 has a zipper 6 which can attach the bottom 5 edge of the rectangular shaped material 2 to the bag 1 when it is closed or unattached the rectangular shaped material 2 when the zipper 6 is open. The top 7 of the rectangular shaped material 2 is unattached to the bag 1. When the zipper 6 is open, the detachable wheeled bag carrying apparatus 8 can pass through the openings at the bottom 5 and top 7 of the rectangular shaped material 2. In this configuration the rectangular shaped material 2 acts as a strap to bind the bag 1 to the detachable wheeled bag carrying apparatus 8. When the zipper 6 is closed, the rectangular shaped material 2 forms a pocket to store the detachable wheeled bag carrying apparatus 8. The bag 1 has an opening at the top 9 to allow entrance into the interior of the bag. The interior of the bag can be used for storage of personal items.

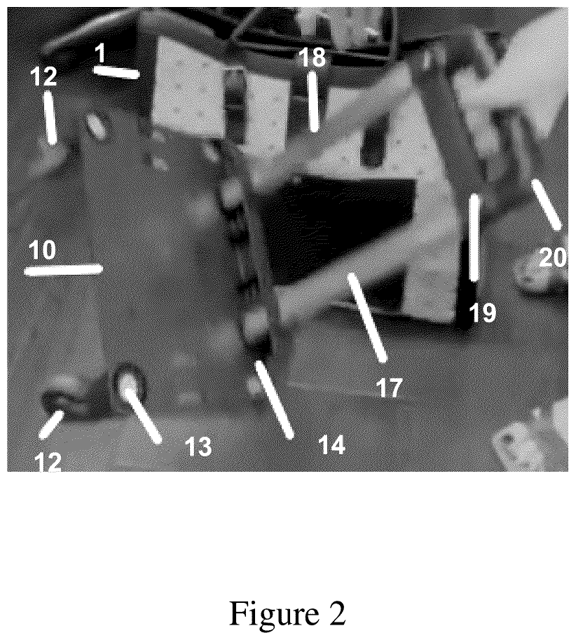

FIG. 2 shows the detachable wheeled bag carrying apparatus (unfolded). The detachable bag carrying apparatus 8 has a base 10 for resting the bag 1. On the reverse side 11 of the base 10 is at least one pair of wheels 12. The wheels 12 are connected 13 to the base 10 in a manner to allow the wheels 12 to rotate in 360° in parallel with the base 10. Connected to one side of the base 10 are hinges 14 connected to telescoping rods 17, 18. The hinges 14 allow the base 10 to rotate 90° in relation to the telescoping rods 17, 18. The base 10 and telescoping rods 17, 18 are in the 90° configuration when in use. The base 10 has tabs 16 in a permanent 90° orientation to the base 10 which abut the telescoping rods 17, 18 when the telescoping rods 17, 18 are in the 90° configuration. There are at least 2 telescoping rods 17, 18 attached to the base. There is a left telescoping rod 17 and a right telescoping rod 18. The telescoping rods 17, 18 are at the maximum length. The maximum length configuration can be locked in place with an internal locking mechanism. The telescoping rods 17, 18 have at least one cross support 19 between the left telescoping rod 17 and right telescoping rod 18 to maintain the telescoping rods 17, 18 in a relatively parallel configuration. At the top of the telescoping rods 17, 18 is a handle 20 with a button 21 for unlocking the telescoping rods 17, 18 from the maximum length configuration. A movable circular shaped material 22 surrounds the bottom section the left telescoping rod 17 and right telescoping rod 18. The circular shaped material 22 on the left telescoping rod 17 and right telescoping rod 18 connects the tab 16 on the base 10 with the left telescoping rod 17 and right telescoping rod 18. When the circular shaped material 22 connects tab 16 on the base 10 with the left telescoping rod 17 and right telescoping rod 18, the 90° configuration of the base 10 and the left telescoping rod 17 and right telescoping rod 18 is fixed in place.

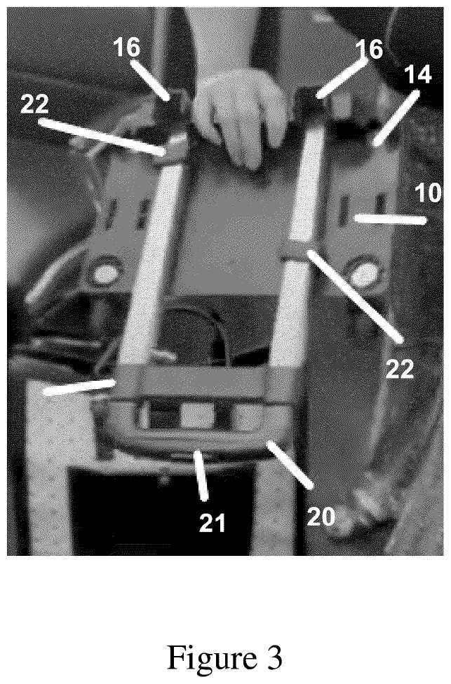

FIG. 3 shows the detachable wheeled bag carrying apparatus (folded). The detachable bag carrying apparatus 8 has a base 10 for resting the bag 1. On the reverse side 11 of the base 10 is at least one pair of wheels 12. The wheels 12 are connected 13 to the base 10 in a manner to allow the wheels 12 to rotate in 360° in parallel with the base 10. Connected to one side of the base 10 are hinges 14 connected to telescoping rods 17, 18. The hinges 14 allow the base 10 to rotate until it is next to the telescoping rods 17, 18. The base 10 and telescoping rods 17, 18 can be folded into a relative 0° configuration for storage. The base 10 has tabs 16 in a permanent 90° orientation to the base 10 which separate from the telescoping rods 17, 18 when the detachable wheeled bag carrying apparatus is folded. The at least 2 telescoping rods 17, 18 attached to the base are the minimum length configuration. The minimum length can be locked in place with an internal locking mechanism. At the top of the telescoping rods 17, 18 is a handle 20 with a button 21 for unlocking the telescoping rods 17, 18 from the minimum length configuration. A movable circular shaped material 22 surrounds the bottom section the left telescoping rod 17 and right telescoping rod 18. The circular shaped material 22 can be moved along the left telescoping rod 17 and right telescoping rod 18 to release the tab 16 on the base 10. When the circular shaped material 22 does not connect tab 16 on the base 10 with the left telescoping rod 17 and right telescoping rod 18, the base 10 and telescoping rods 17, 18 can be folded into the 0° configuration.

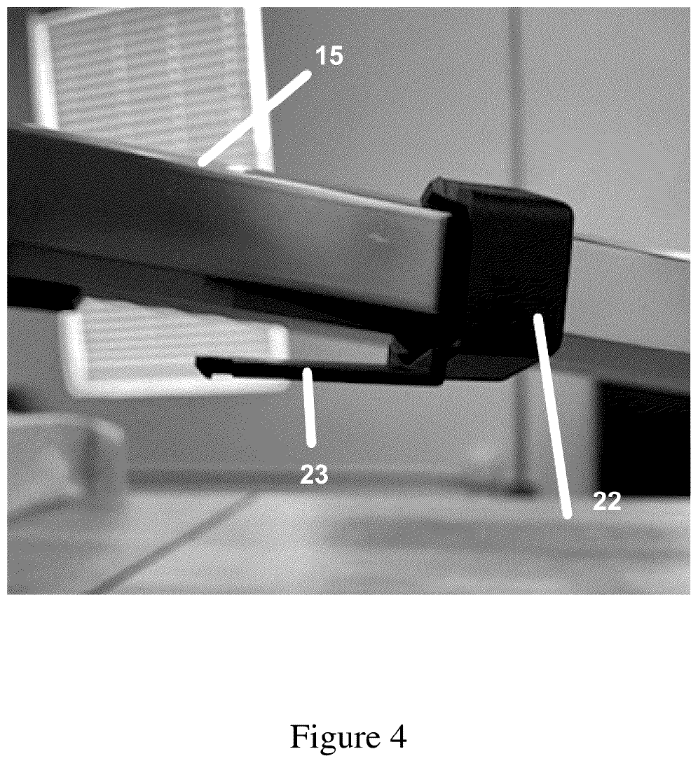

FIG. 4 shows a close-up of a telescoping rod 15 with a circular shaped material 22 and release 23.

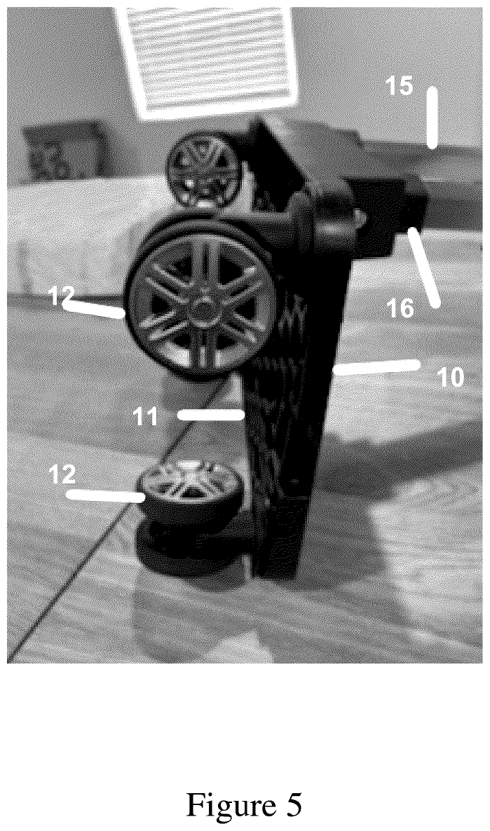

FIG. 5 shows the distal end of the detachable wheeled bag carrying apparatus 8. The left telescoping rod 17 and right telescoping rod 18 are 90° to the top surface of base 10. The wheels 12 are attached to the bottom surface of the base 11.

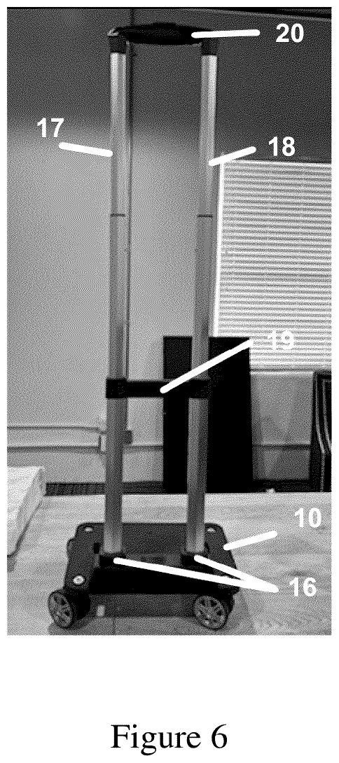

FIG. 6 shows the detachable wheeled bag carrying apparatus 8 in the standing unfolded position. The handle 20 is attached to the tops of the left telescoping rod 17 and right telescoping rod 18. There is a cross support 19 between the left telescoping rod 17 and right telescoping rod 18. The left telescoping rod 17 and right telescoping rod 18 connect to the base 10 at the tabs 16.

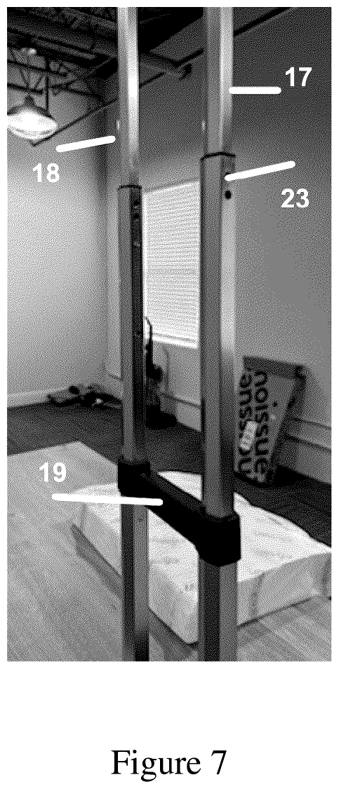

FIG. 7 shows the release 23 on the left telescoping rod 17.

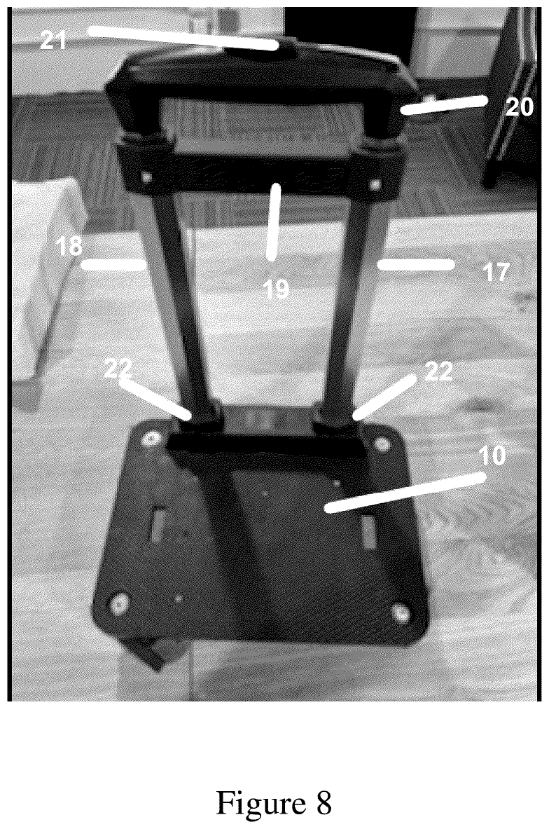

FIG. 8 shows unfolded detachable wheeled bag carrying apparatus 8. There is a button 21 at the top of the handle 20. The cross support 19 is between unextended left telescoping rod 17 and right telescoping rod 18. The circular shaped material 22 maintains the 90° configuration with the base 10.

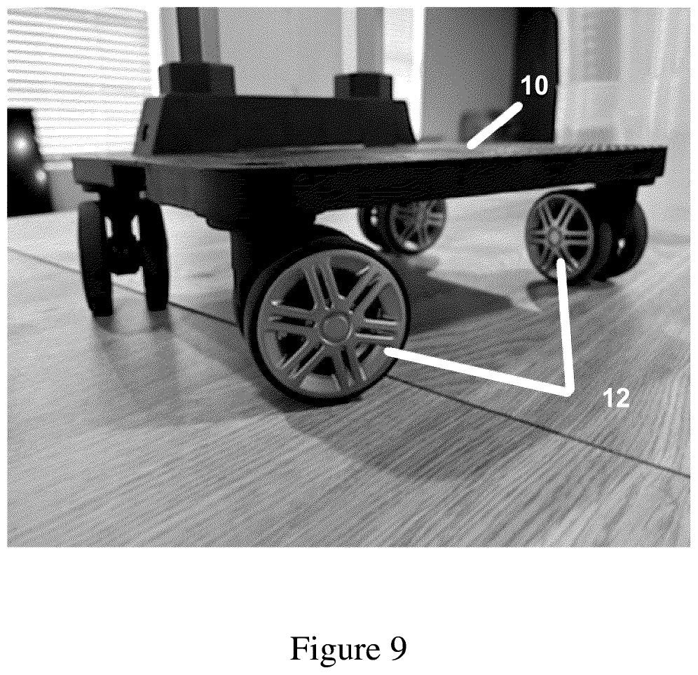

FIG. 9 is a close-up showing the attachment of the wheels 12 to the base 10.

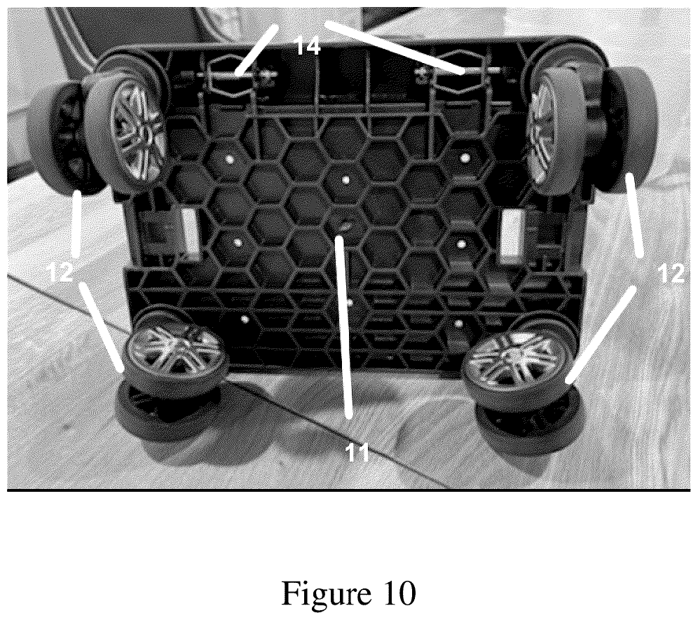

FIG. 10 shows the underside of the detachable wheeled bag carrying apparatus 8. The wheels 12 are attached at the corners of the reverse side of the base 11. The hinges 14 allow the movement of the base 10 in relation to the position of the left telescoping rod 17 and right telescoping rod 18.

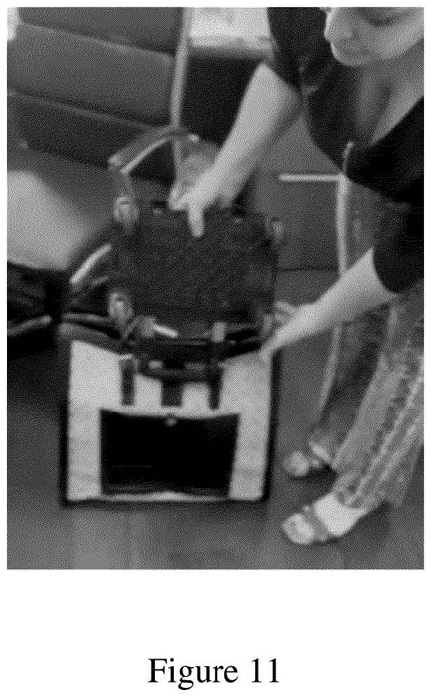

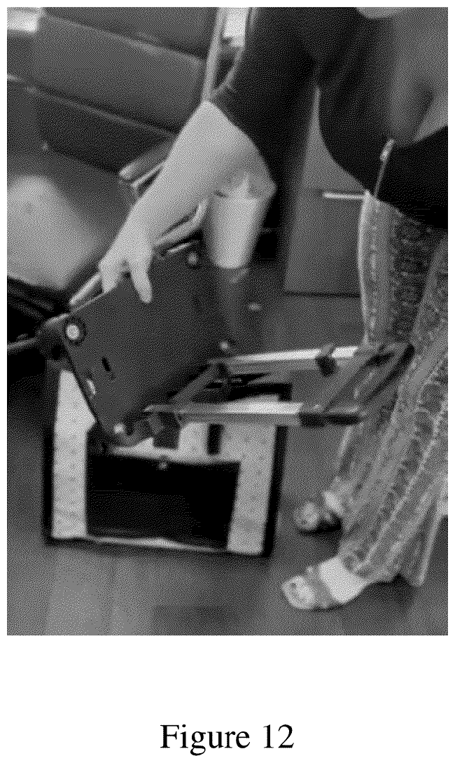

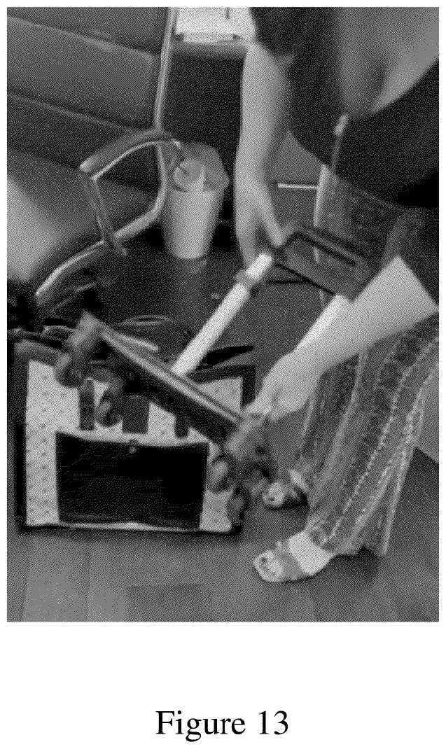

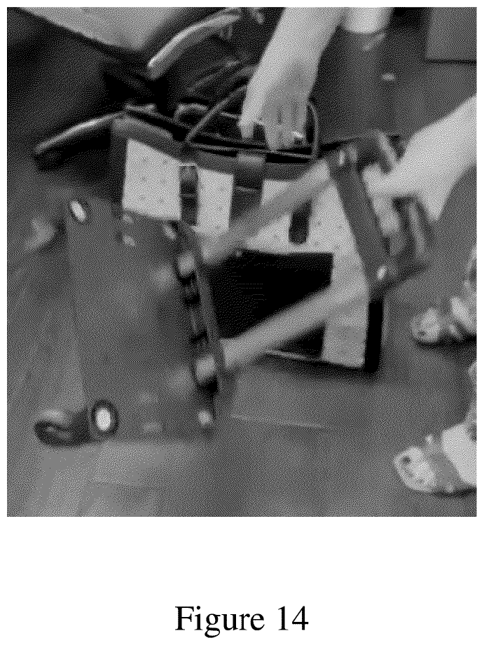

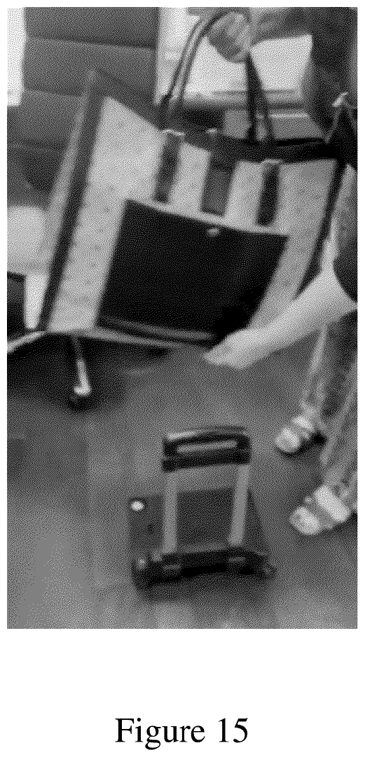

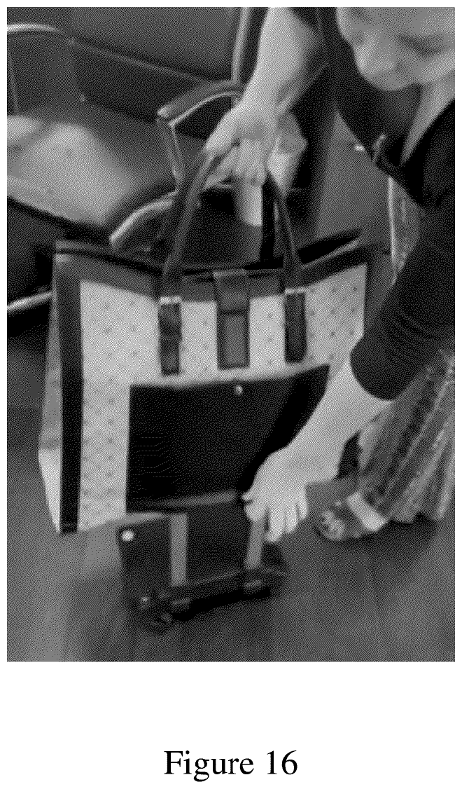

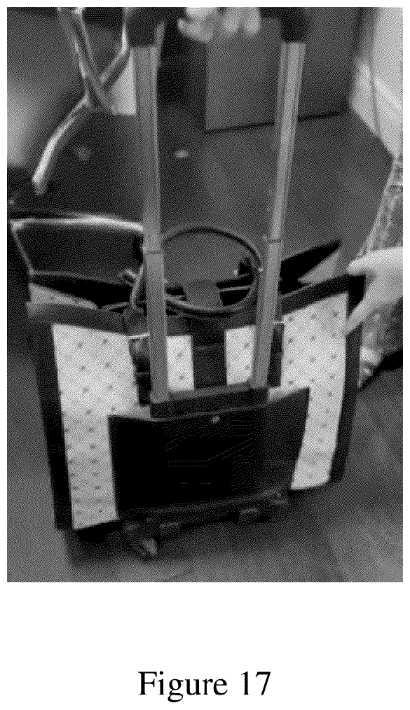

FIGS. 11 to 17 show the sequence of steps to remove the detachable wheeled bag carrying apparatus 8 from the bag 1 to its working configuration. The detachable wheeled bag carrying apparatus 8 can be folded and stored inside the bag 1. The detachable wheeled bag carrying apparatus 8 is removed from the bag 1 (FIG. 11). The detachable wheeled bag carrying apparatus 8 is unfolded (FIG. 12) and the circular shaped material 22 is pushed down around the tabs 16 to maintain the 90° configuration with the base 10 (FIG. 13). The bag 1 is then positioned so the rectangular shaped material 2, with the zipper 6 open at the bottom 5, will slip over the detachable wheeled bag carrying apparatus 8 (FIGS. 14-16). The handle 20 is gripped and the left telescoping rod 17 and right telescoping rod 18 are extended to begin use.

The following is a general description of the bag and detachable wheeled bag carrying apparatus. The bag 1 has a rectangular shaped material 2 on one side of the bag 1. The rectangular shaped material 2 is permanently attached to the bag 1 along the left side 3 and right side 4 of the rectangular shaped material 2. The bottom 5 of the rectangular shaped material 2 has a zipper 6 which can attach the bottom 5 edge of the rectangular shaped material 2 to the bag 1 when it is closed or unattached the rectangular shaped material 2 when the zipper 6 is open. The top 7 of the rectangular shaped material 2 is unattached to the bag 1. When the zipper 6 is open, the detachable wheeled bag carrying apparatus 8 can pass through the openings at the bottom 5 and top 7 of the rectangular shaped material 2. In this configuration the rectangular shaped material 2 acts as a strap to bind the bag 1 to the detachable wheeled bag carrying apparatus 8. When the zipper 6 is closed, the rectangular shaped material 2 forms a pocket to store the detachable wheeled bag carrying apparatus 8. The bag 1 has an opening at the top 9 to allow entrance into the interior of the bag. The interior of the bag can be used for storage of personal items.

The detachable bag carrying apparatus 8 has a base 10 for resting the bag 1. On the reverse side 11 of the base 10 is at least one pair of wheels 12. The wheels 12 are connected 13 to the base 10 in a manner to allow the wheels 12 to rotate in 360° in parallel with the base 10. Connected to one side of the base 10 are hinges 14 connected to telescoping rods 17, 18. The hinges 14 allow the base 10 to rotate 90° in relation to the telescoping rods 17, 18. The base 10 and telescoping rods 17, 18 are in the 90° configuration when in use. However, the base 10 and telescoping rods 17, 18 can be folded into a relative 0° configuration for storage. The base 10 has tabs 16 in a permanent 90° orientation to the base 10 which abut the telescoping rods 17, 18 when the telescoping rods 17, 18 are in the 90° configuration.

There are at least 2 telescoping rods 17, 18 attached to the base. There is a left telescoping rod 17 and a right telescoping rod 18. The telescoping rods 17, 18 have 2 configurations: a minimum length and a maximum length. The minimum length configuration and maximum length configuration can be locked in place with an internal locking mechanism. The telescoping rods 17, 18 have at least one cross support 19 between the left telescoping rod 17 and right telescoping rod 18 to maintain the telescoping rods 17, 18 in a relatively parallel configuration. At the top of the telescoping rods 17, 18 is a handle 20 with a button 21 for unlocking the telescoping rods 17, 18 from the minimum length and maximum length configurations. A movable circular shaped material 22 surrounds the bottom section the left telescoping rod 17 and right telescoping rod 18. The circular shaped material 22 can be moved down the left telescoping rod 17 and right telescoping rod 18 to connect the tab 16 on the base 10 with the left telescoping rod 17 and right telescoping rod 18. When the circular shaped material 22 connects tab 16 on the base 10 with the left telescoping rod 17 and right telescoping rod 18, the 90° configuration of the base 10 and the left telescoping rod 17 and right telescoping rod 18 is fixed in place. When the circular shaped material 22 does not connect tab 16 on the base 10 with the left telescoping rod 17 and right telescoping rod 18, the base 10 and telescoping rods 17, 18 can be folded into the 0° configuration.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

Room for improvement exists over the prior art, however, in areas including in the design and manufacture of fashionable luxury purses or bags used for conventions or business trips and in the design and manufacture of fashionable luxury purses or bags that is detachable, convenient, easy to use, sturdy, long lasting, durable, and versatile. Needs or potential areas for benefit exist in these areas individually as well as in various combinations of these areas, as further examples. Potential for benefit or improvement exists in these and other areas that may be apparent to a person of skill in the art having studied this document.

### SUMMARY OF PARTICULAR EMBODIMENTS OF THE INVENTION

The following presents a summary of the present invention. This summary is not an extensive overview of all contemplated embodiments and is intended to neither identify key or critical elements of all embodiments nor delineate the scope of any or all embodiments. Its purpose is to present some embodiments before a detailed description that is presented later.

The principal object of the present invention is directed to a fashionable or luxury bag and detachable wheeled bag carrying apparatus.

It is an object of the present invention that the detachable wheeled bag carrying apparatus can be easily and quickly attached to the bag.

It is an object of the present invention that the detachable wheeled bag carrying apparatus can be easily and quickly detached from a bag.

It is an object of the present invention that the detachable wheeled bag carrying apparatus can be stored on the bag.

It is an object of the present invention that the detachable wheeled bag carrying apparatus can be compact when stored.

It is an object of the present invention that the detachable wheeled bag carrying apparatus can be light in weight.

Various embodiments are detachable, for example, to reduce weight during use. Particular embodiments have wheels for rolling. Various embodiments provide detachability while also being convenient and easy to use, sturdy, long lasting, durable, and versatile. Various embodiments are described herein as examples, and other various benefits of certain embodiments are described herein or may be apparent to a person of skill in this area of technology.

In one embodiment of the disclosed method and system the bag has a rectangular shaped material on one side. In another embodiment of the disclosed method and system the bag has a rectangular shaped material on both sides.

In one embodiment of the disclosed method and system the bag is a purse. In one embodiment of the disclosed method and system the purse is a fashionable purse. In one embodiment of the disclosed method and system the fashionable purse is a luxury purse.

In one embodiment of the disclosed method and system the rectangular shaped material is open at the top and bottom to form a band of material for the telescoping rods of the detachable wheeled bag carrying apparatus to pass through and hold the bag to the detachable wheeled bag carrying apparatus.

In one embodiment of the disclosed method and system the rectangular shaped material is open at the top and closed at the bottom to form a pocket to hold the folded detachable wheeled bag carrying.

In one embodiment of the disclosed method and system the bottom of the rectangular shaped material is closed with Velcro. In one embodiment of the disclosed method and system the bottom of the rectangular shaped material is closed with snaps.

In one embodiment of the disclosed method and system the reverse side of the base has at least one pair of wheels (2 wheels total). In one embodiment of the disclosed method and system the reverse side of the base has at least two pair of wheels (4 wheels total). In one embodiment of the disclosed method and system the reverse side of the base has more than two pair of wheels (more than 4 wheels total).

In one embodiment of the disclosed method and system the telescoping rods are at a minimum length. In one embodiment of the disclosed method and system the telescoping rods are at a maximum length.

In one embodiment of the disclosed method and system the telescoping rods have an internal lock. In one embodiment of the disclosed method and system the telescoping rods have an external lock.

In one embodiment of the disclosed method and system the handle at the top of the telescoping rods connects the telescoping rods. In one embodiment of the disclosed method and system the handle at the top of the telescoping rods is a separate handle on each telescoping rod.

In one embodiment of the disclosed method and system there is at least one cross support between the telescoping rods. In one embodiment of the disclosed method and system there are at least two cross supports between the telescoping rods. In one embodiment of the disclosed method and system there are more than two cross supports between the telescoping rods.

In one embodiment of the disclosed method and system the handle has a button to unlock the telescoping rods. In one embodiment of the disclosed method and system the handle has a button to unlock the telescoping rods from the minimum length. In one embodiment of the disclosed method and system the handle has a button to unlock the telescoping rods from the maximum length.

In one embodiment of the disclosed method and system the button on the handle is a switch. In another embodiment of the disclosed method and system the switch is a toggle. In another embodiment of the disclosed method and system the switch is a slide.

In one embodiment of the disclosed method and system the circular shaped material on a telescoping rod is plastic. In one embodiment of the disclosed method and system the circular shaped material on a telescoping rod is metal.

In one embodiment of the disclosed method and system the detachable wheeled bag carrying apparatus is made of metal. In one embodiment of the disclosed method and system the detachable wheeled bag carrying apparatus is made of plastic. In one embodiment of the disclosed method and system the detachable wheeled bag carrying apparatus is made of a combination of metal and plastic.

1. An article of manufacture comprising:
a bag with a rectangular shaped material on one side of the bag; wherein the rectangular shaped material is permanently attached to the bag along the left side and right side of the rectangular shaped material; the bottom of the rectangular shaped material has a zipper which can attach the bottom edge of the rectangular shaped material to the bag; and the top of the rectangular shaped material is unattached to the bag;
the bag has an opening at the top to allow entrance into the interior of the bag; and
the detachable bag carrying apparatus has a base for resting the bag with at least one pair of wheels on the reverse side of the base;
the wheels are connected to the base in a manner to allow the wheels to rotate in 360° in parallel with the base;
connected to one side of the base is a hinge connected to at least 2 telescoping rods with a left telescoping rod and a right telescoping rod;
the base has tabs in a permanent 90° orientation to the base which abut the telescoping rod when the telescoping rod is in a 90° configuration;
at least one cross support between the left telescoping rod and right telescoping rod to maintain the telescoping rods in a relatively parallel configuration;
at the top of the left telescoping rod and right telescoping rod is a handle connecting the left telescoping rod and right telescoping rod;
the handle has a button to unlock the left telescoping rod and the right telescoping rod from a minimum length and a maximum length configuration;
the left telescoping rod and the right telescoping rod have an internal locking mechanism; and
the left telescoping rod and the right telescoping rod have a movable circular shaped material which surrounds the bottom sections of the left telescoping rod and the right telescoping rod; wherein the circular shaped material can be moved down the left telescoping rod and right telescoping rod to connect the tab on the base with the left telescoping rod and right telescoping rod.

2. The article of manufacture of claim 1 wherein the rectangular shaped material is selected from the group consisting of cloth, leather, plastic, and net.

3. The article of manufacture of claim 1 wherein the rectangular shaped material is permanently attached to the bag along the left side and right side of the rectangular shaped material with a material selected from the group consisting of sewing tread, Velcro, glue, rivets, and grommets.

4. The article of manufacture of claim 1 wherein the detachable bag carrying apparatus is stored in the rectangular shaped material when the bottom is closed by the zipper.

5. The article of manufacture of claim 1 wherein the left telescoping rod and a right telescoping rod of the detachable bag carrying apparatus pass through the rectangular shaped material when the bottom is open by the zipper.

6. The article of manufacture of claim 1 wherein the bag and the detachable wheeled bag carrying apparatus can be folded.

7. The article of manufacture of claim 1 wherein the bag and the detachable wheeled bag carrying apparatus can be opened into a working configuration of approximately 90°.
